(19) United States
(12) Patent Application Publication
(10) Pub. No.: US 2021/0272224 A1
(43) Pub. Date: Sep. 2, 2021

(54) PLACEMENT PLATFORM WITH DESIRABILITY INDICATORS

(71) Applicant: SJ MedConnect, Inc., Santa Clara, CA (US)

(72) Inventors: Jason Reminick, Santa Clara, CA (US); Suzanne Karan, Rochester, NY (US)

(21) Appl. No.: 16/805,594

(22) Filed: Feb. 28, 2020

(51) Int. Cl. G06Q 50/20; G09B 7/02; G06F 16/9535

(52) U.S. Cl. CPC G06Q 50/2053; G06F 16/9535; G09B 7/02

(57) ABSTRACT

Program placement with desirability indicators can include: generating a user interface that includes an indicator of a relative desirability of at least one of a plurality of programs registered on a placement platform among a set of candidates who use the placement platform to place among the programs; and determining the relative desirability in response to a store of history data pertaining to how the candidates used the placement platform to place among the programs during at least one placement season for the programs.

### BACKGROUND

A placement platform can enable candidates seeking placement among highly sought-after limited-capacity programs to communicate with those programs, arrange interviews, etc. For example, a placement platform can enable medical school graduates to arrange interviews for placement among a variety of medical residency programs.

A placement platform can enable a candidate seeking placement to browse information about each available program, e.g., location, program highlights, types of candidates sought, etc. A placement platform can enable administrators of available programs to view profile information for candidates, e.g., location and demographic information, relevant test scores, etc.

### SUMMARY

In general, in one aspect, the invention relates to a placement platform with desirability indicators. A placement platform according to the invention can include: a user interface that includes an indicator of a relative desirability of at least one of a plurality of programs registered on the placement platform among a set of candidates who use the placement platform to place among the programs; and a data analyzer that determines the relative desirability in response to a store of history data pertaining to how the candidates used the placement platform to place among the programs during at least one placement season for the programs.

In general, in another aspect, the invention relates to a method for program placement with desirability indicators. The method can include: generating a user interface that includes an indicator of a relative desirability of at least one of a plurality of programs registered on a placement platform among a set of candidates who use the placement platform to place among the programs; and determining the relative desirability in response to a store of history data pertaining to how the candidates used the placement platform to place among the programs during at least one placement season for the programs.

Other aspects of the invention will be apparent from the following description and the appended claims.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 illustrates a placement platform with desirability indicators in one or more embodiments.

FIG. 2A-2B are examples of user interfaces with desirability indicators embodied in an administrator dashboard of a program administrator registered on a placement platform.

FIG. 3 illustrates an example of a set of history data pertaining to how candidates use a placement platform to seek placement among programs in one or more embodiments.

FIG. 4 illustrates an example of a user interface with desirability indicators embodied as a home page of a candidate registered on a placement platform.

FIGS. 5-6 illustrate methods for providing desirability indicators for program placement in one or more embodiments.

FIG. 7 illustrates an example cloud-based implementation of a placement platform with desirability indicators.

FIG. 8 illustrates a computing system upon which portions of a placement platform with desirability indicators can be implemented.

### DETAILED DESCRIPTION

Reference will now be made in detail to the various embodiments of the present disclosure, examples of which are illustrated in the accompanying drawings. Like elements in the various figures are denoted by like reference numerals for consistency. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, have not been described in detail so as not to unnecessarily obscure aspects of the present disclosure.

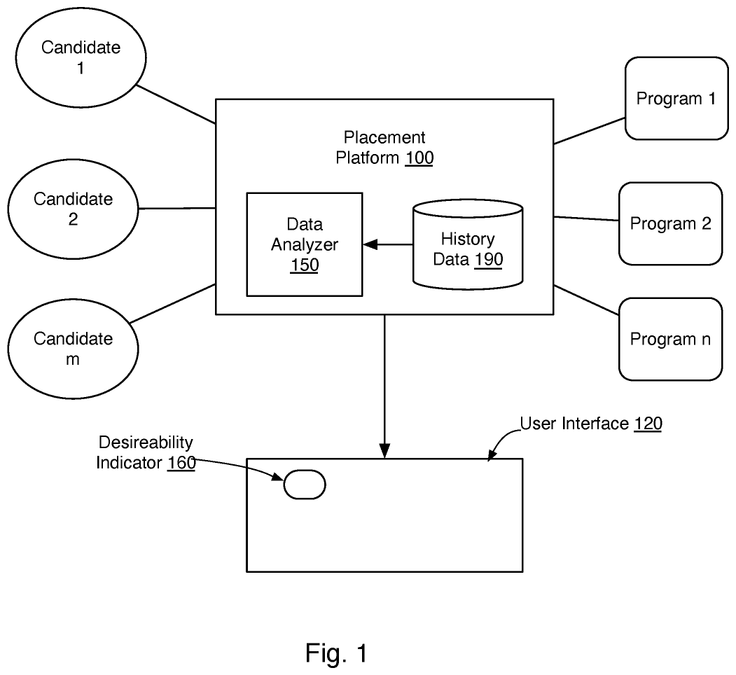

FIG. 1 illustrates a placement platform 100 in one or more embodiments. The placement platform 100 generates a user interface 120 that includes a desirability indicator 160 of a relative desirability of one or more of a set of programs 1-n registered on the placement platform 100 among a set of candidates 1-m who use the placement platform 100 to place among the programs 1-n.

The desirability indicator 160 in the user interface 120 can include any combination of text, graphics, multimedia, etc., to convey a relative desirability of one or more of the programs 1-n among the candidates 1-m. For example, the desirability indicator 160 can indicate a rank of one or more of the program 1-n, or depict a relative desirability using graphical indicators, colors, etc.

The placement platform 100 includes a data analyzer 150 that determines the relative desirability of each of the programs 1-n based on a store of history data 190. The history data 190 includes a variety of data describing how the candidates 1-m used the placement platform 100 to place among the programs 1-n during at least one placement season for the programs 1-n.

In one or more embodiments, the user interface 120 is presented to administrators of the programs 1-n who seek to learn how their program stacks up against other programs, e.g., those programs they regard as competitors, in the eyes of the candidates 1-m. In one or more embodiments, the user interface 120 can be an administrator dashboard that enables an administrator to browse among a variety of profiles the programs 1-n and view desirability indicators for those programs.

In one or more embodiments, the user interface 120 is presented to any of the candidates 1-m who seek to learn how the programs 1-n stack up against one another in the eyes of their peers. For example, the user interface 120 can be a home page of a current one of the candidates 1-m that enables the current candidate to browse among a variety of profiles of the programs 1-n and view desirability indicators.

In one or more embodiments, the programs 1-n are medical residency programs, e.g. residency programs associated with medical schools or other institutions, and the candidates 1-m include medical school graduates who sought placement among the residency programs using the placement platform 100 during one or more placement seasons for the residency programs.

In the following examples, the programs 1-n include the Stanford Health Care Anesthesiology Program, the Brigham and Women's Hospital Anesthesiology Program, the Massachusetts General Hospital Anesthesiology Program, the University of California San Francisco (UCSF) Anesthesiology Program, and the University of Washington Anesthesiology Program.

In one or more embodiments, the data analyzer 150 determines a relative desirability to be depicted with the desirability indicator 160 by determining a rate of completion of one or more events associated with the programs 1-n. For example, in one or more embodiments, the history data 190 specifies when one or more of the candidates 1-m are invited to schedule an interview with the Stanford Health Care Anesthesiology Program and the Brigham and Women's Hospital Anesthesiology Program, and further specifies if and when those invites cumulated in a completed interview. If, for example, the Stanford Health Care Anesthesiology Program had a higher percentage of invites that culminated in an interview than the Brigham and Women's Hospital Anesthesiology Program, then the Stanford Health Care Anesthesiology Program gets a higher relative desirability score.

In one or more embodiments, the data analyzer 150 determines a relative desirability by first determining a set of competitors among the programs 1-n in response to the history data 190 and then determining a relative desirability of each determined competitor. For example, the data analyzer 150 can determine that the Massachusetts General Hospital Anesthesiology Program and the UCSF Anesthesiology Program are competitors and then determine a relative desirability for the Massachusetts General Hospital Anesthesiology Program and a relative desirability for the UCSF Anesthesiology Program based on, e.g., invites that culminate in an actual interview as indicated in the history data 190.

In one or more embodiments, the data analyzer 150 determines which of the programs 1-n are competitors by determining an overlap among the pools of the candidates 1-m who sought placement in the programs 1-n. For example, if a relatively high percentage of the candidates 1-m who sought placement at the Massachusetts General Hospital Anesthesiology Program also sought placement at the UCSF Anesthesiology Program, then it indicates that the Massachusetts General Hospital Anesthesiology Program and the UCSF Anesthesiology Program are competitors.

In one or more embodiments, the data analyzer 150 determines which of the programs 1-n are competitors by determining an overlap in one or more aspects of a respective candidate profile of each of the candidates 1-m who sought placement in the respective programs 1-n. For example, if a relatively high percentage of the candidates 1-m who sought placement at both the Massachusetts General Hospital Anesthesiology Program and the UCSF Anesthesiology Program share a demographic characteristic, place of birth, percentile ranks in test scores, etc., then it indicates that the Massachusetts General Hospital Anesthesiology Program and the UCSF Anesthesiology Programs are competitors.

In one or more embodiments, the data analyzer 150 determines which of the programs 1-n are competitors by determining an overlap in questionnaire data obtained from the candidates 1-m. For example, if a relatively high percentage of the candidates 1-m who sought placement at the Massachusetts General Hospital Anesthesiology Program and the UCSF Anesthesiology Program provided similar answers to similar program questionnaires, then it indicates that the Massachusetts General Hospital Anesthesiology Program and the UCSF Anesthesiology Program are competitors.

In one or more embodiments, the data analyzer 150 determines which of the programs 1-n are competitors by determining an overlap in event dates associated with the programs 1-n. For example, if a relatively high percentage of event dates, e.g., interview dates, for the Massachusetts General Hospital Anesthesiology Program overlap with event dates for the UCSF Anesthesiology Program, then it indicates that the Massachusetts General Hospital Anesthesiology Program and the UCSF Anesthesiology Program are competitors.

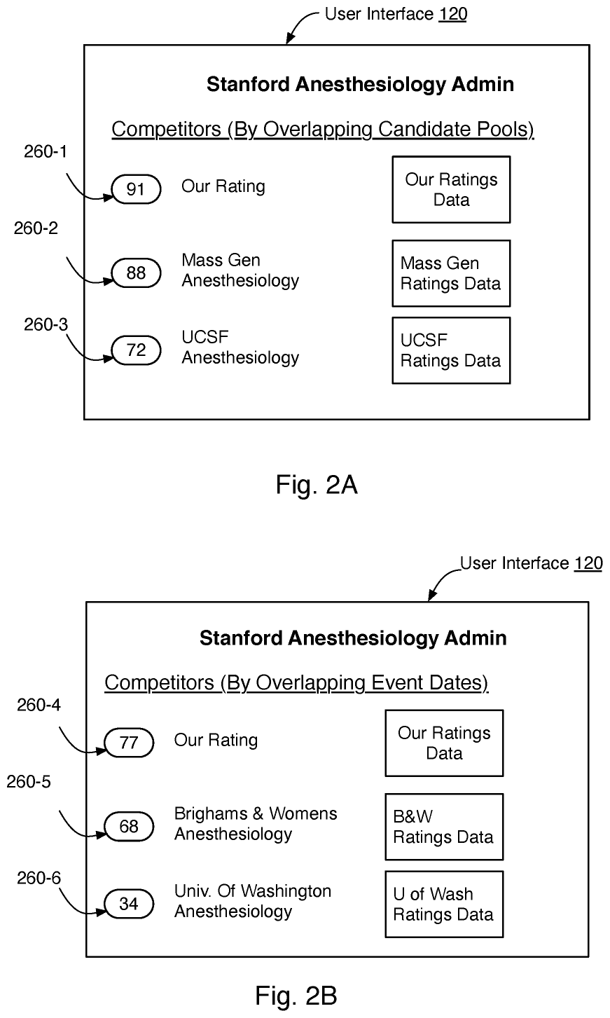

FIG. 2A is an example of the user interface 120 embodied an administrator dashboard for the Stanford Health Care Anesthesiology Program in which the competitors to the Stanford Health Care Anesthesiology Program are based on the overlapping pools of the candidates 1-m. The competitors to the Stanford Health Care Anesthesiology Program in this example are the Massachusetts General Hospital Anesthesiology Program and the UCSF Anesthesiology Program based on the overlapping pools of the candidates 1-m as indicated in the history data 190. The overlapping candidate pools can be based on, e.g., the candidates 1-m who received invites from the Stanford Health Care Anesthesiology Program and the Massachusetts General Hospital Anesthesiology Program and the UCSF Anesthesiology Program, the candidates 1-m who completed interviews at the Stanford Health Care Anesthesiology Program and the Massachusetts General Hospital Anesthesiology Program and the UCSF Anesthesiology Program, etc.

The user interface 120 in the example of FIG. 2A includes a set of desirability indicators 260-1 through 260-3 indicating the relative desirability of the Stanford Health Care Anesthesiology Program (“Our Program” in Stanford's dashboard) and the Massachusetts General Hospital Anesthesiology Program and the UCSF Anesthesiology Program, respectively. In this example, the desirability indicators 260-1 through 260-3 depict number ratings, e.g., on a scale from 0 to 100.

The desirability indicators 260-1 through 260-3 can be based on any of the history data 190. For example, the desirability indicators 260-1 through 260-3 can be based the interview completion rates of the candidates 1-m who were invited to the Stanford Health Care Anesthesiology Program and the Massachusetts General Hospital Anesthesiology Program and the UCSF Anesthesiology Program. For example, if 88 percent of the candidates 1-m invited to the Stanford Health Care Anesthesiology Program and to the Massachusetts General Hospital Anesthesiology Program and to the UCSF Anesthesiology Programs completed an interview at the Massachusetts General Hospital Anesthesiology Program then the Massachusetts General Hospital Anesthesiology Program gets the desirability indicator 260-2 of 88.

The user interface 120 in the example of FIG. 2A includes respective ratings data panels for the Stanford Health Care Anesthesiology Program and the Massachusetts General Hospital Anesthesiology Program and the UCSF Anesthesiology Program. The ratings data panels in the user interface 120 can depict any of the data of the respective candidates 1-m upon which the respective desirability indicators 260-1 through 260-3 are based. For example, the ratings data panels in the user interface 120 can provide charts, graphs, etc., summarizing candidate data for the respective programs.

FIG. 2B is an example of the user interface 120 embodied an administrator dashboard for the Stanford Health Care Anesthesiology Program in which the competitors to the Stanford Health Care Anesthesiology Program are based on overlapping event dates, e.g., program interview dates. The competitors to the Stanford Health Care Anesthesiology Program in this example are the Brigham and Women's Anesthesiology Program and the University of Washington Anesthesiology Program as indicated in the history data 190.

The user interface 120 in the example of FIG. 2B includes a set of respective desirability indicators 260-3 through 260-6 indicating the relative desirability of the Stanford Health Care Anesthesiology Program and the Brigham and Women's Anesthesiology Program and the University of Washington Anesthesiology Program. The desirability indicators 260-3 through 260-6 can be based on any of the history data 190.

For example, the desirability indicators 260-3 through 260-6 can be based on a particular data point of interest pertaining to the candidates 1-m who were invited to the Stanford Health Care Anesthesiology Program and the Brigham and Women's Anesthesiology Program and the University of Washington Anesthesiology Program, e.g., demographic characteristics, geography data, questionnaire answers, etc. If 68 percent of the candidates 1-m invited to the Brigham and Women's Anesthesiology Program share that particular data point of interest then the desirability indicator 260-5 is 68. Likewise, if 34 percent of the candidates 1-m invited to the University of Washington Anesthesiology Program share that particular data point of interest then the desirability indicator 260-6 is 34.

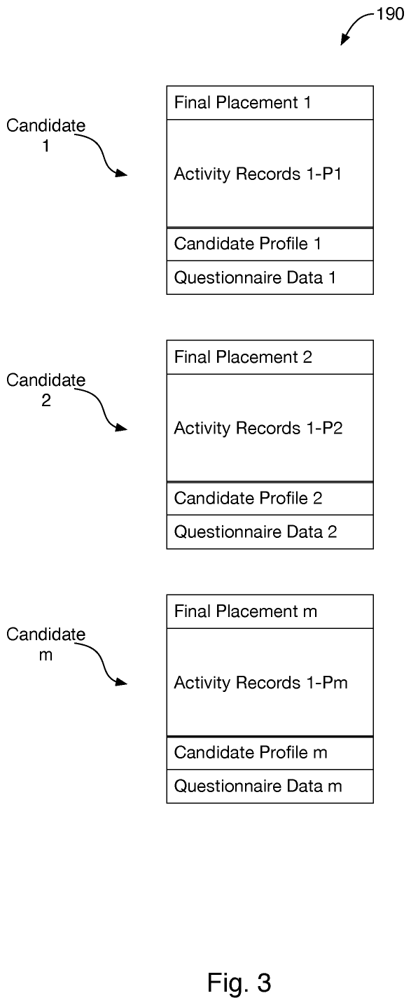

FIG. 3 illustrates an example of the history data 190 in one or more embodiments. The history data 190 includes a respective set of history data for each of the candidates 1-m who used the placement platform 100 to place among the programs 1-n during one or more placement seasons for the programs 1-n. Each set of history data for the candidates 1-m includes a respective final placement 1-m which specifies in which of the programs 1-n the respective candidate 1-m placed, a respective set of activity records 1-P1 through 1-Pm describing a set of activities undertaken by the respective candidates 1-m in reaching the respective final placement 1-m, a respective candidates profile 1-m of each respective candidate 1-m, and a respective set of questionnaire data 1-m of each of the respective candidates 1-m.

Examples of activities logged in the activity records 1-P1 through 1-Pm include initiating a placement process with a specified one of the programs 1-n, receiving an invitation from a specified one of the programs 1-n to schedule an interview, scheduling an interview with a specified one of the programs 1-n, cancelling an interview with a specified one of the programs 1-n, rescheduling an interview with a specified one of the programs 1-n, being placed on a waitlist for a specified one of the programs 1-n etc. The activity records 1-P1 through 1-Pm can include parameters for the respective activities, e.g., date and time parameters.

Examples of the candidate profiles 1-m include candidate identifiers, demographic data, e.g., age, gender, race, place of birth, etc., educational data, e.g., medical school attended, relevant test scores, etc., extracurricular activities, awards, etc.

The questionnaire data 1-m specifies answers to specific questions presented to the respective candidate 1-m by the programs 1-n. In one or more embodiments, the placement platform 100 provides administrators of the programs 1-n with a mechanism for presenting questionnaires to the candidates 1-m. The questionnaires can be tailored to the specific needs of the programs 1-n. For example, if the Massachusetts General Hospital Anesthesiology Program seeks candidates who are left-handed, or bilingual, or who speak a particular language, or who have had particular life experiences, that data can be acquired in a questionnaire and used as a basis for subsequent data analysis.

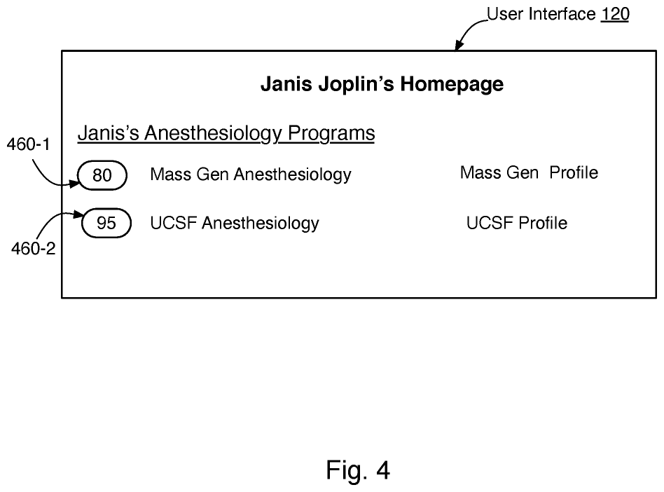

FIG. 4 illustrates an example of the user interface 120 embodied as a home page of a current candidate, Janis Joplin, registered on the placement platform 100. In one or more embodiments, the user interface 120 enables Janis to browse and view profiles of the programs 1-n. In this example, Janis views the Massachusetts General Hospital Anesthesiology Program and the UCSF Anesthesiology Program, and views respective desirability indicators 460-1 and 460-2. The Massachusetts General Hospital Anesthesiology Program and the UCSF Anesthesiology Program may have been selected by Janis in a search of the placement platform 100, e.g., a search of program profiles of the programs 1-n registered on the placement platform 100. The desirability indicators 460-1 and 460-2 can be based on any of the history data 190, e.g., interview completion rates, candidate demographics, questionnaire answers, etc.

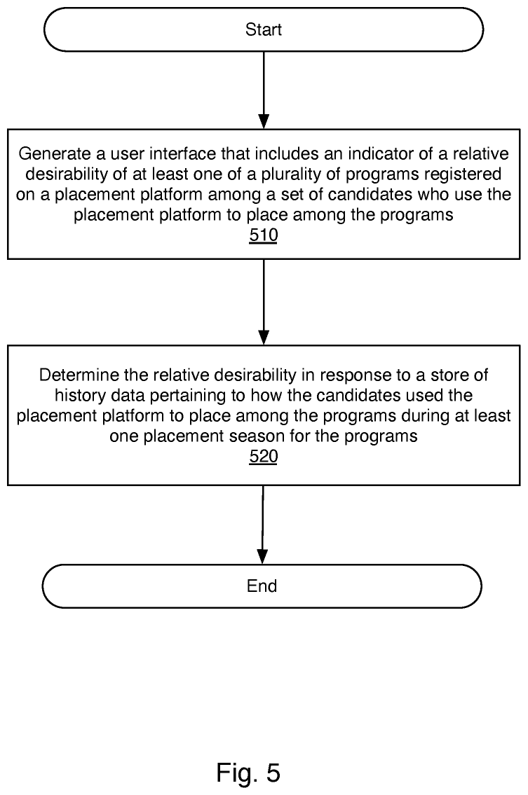

FIG. 5 illustrates a method for providing a desirability indicator for program placement in one or more embodiments. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 5 should not be construed as limiting the scope of the invention.

At step 510, a user interface is generated that includes an indicator of a relative desirability of at least one of a plurality of programs registered on a placement platform among a set of candidates who use the placement platform to place among the programs. The user interface at step 510 can be an administrator dashboard that enables an administrator of a program to compare a desirability of their program against other programs. The user interface at step 510 can be a candidate homepage that enables the respective candidate to explore the desirability of various programs registered on the placement platform.

At step 520, the relative desirability is determined in response to a store of history data pertaining to how the candidates used the placement platform to place among the programs during at least one placement season for the programs. The relative desirability can be based on prior scheduling behaviors of the candidates, demographics of the candidates, questionnaire answers of the candidates, etc.

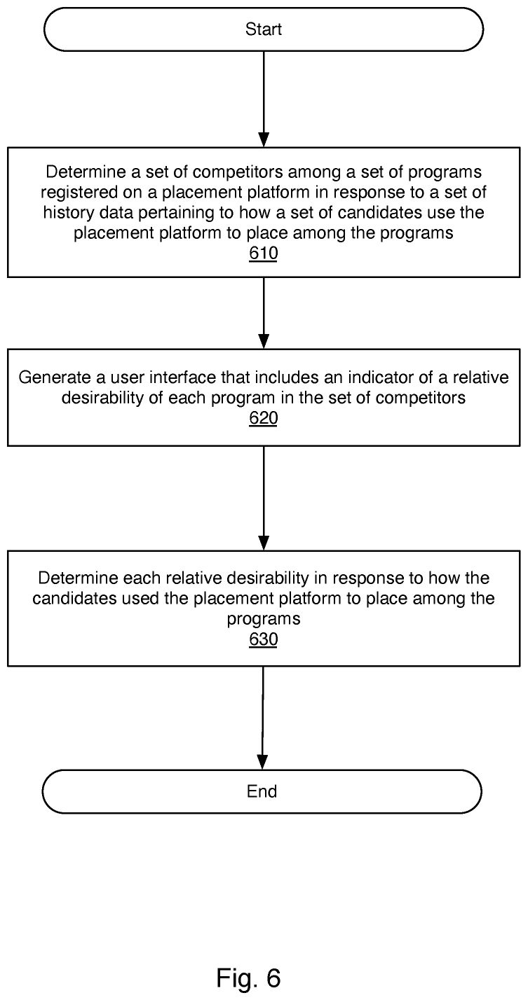

FIG. 6 illustrates a method for providing a desirability indicator that can enable administrators of programs to compare the desirability of their program against other programs regarded as competitors.

At step 610, a set of competitors are determined from among a set of programs registered on a placement platform in response to a set of history data pertaining to how a set of candidates used the placement platform to place among the programs. The competitors can be based on candidate pool overlaps, event date overlaps, candidate demographics, questionnaire answers, etc., as logged in the history data.

At step 620, a user interface is generated that includes an indicator of a relative desirability of each program in the set of competitors. The user interface can be an administrator dashboard that enables an administrator of a program to compare a desirability of their program against competitor programs.

At step 630, each relative desirability is determined in response to how the candidates used the placement platform to place among the programs. The relative desirability can be based on prior scheduling behaviors of the candidates, demographics of the candidates, questionnaire answers of the candidates, etc.

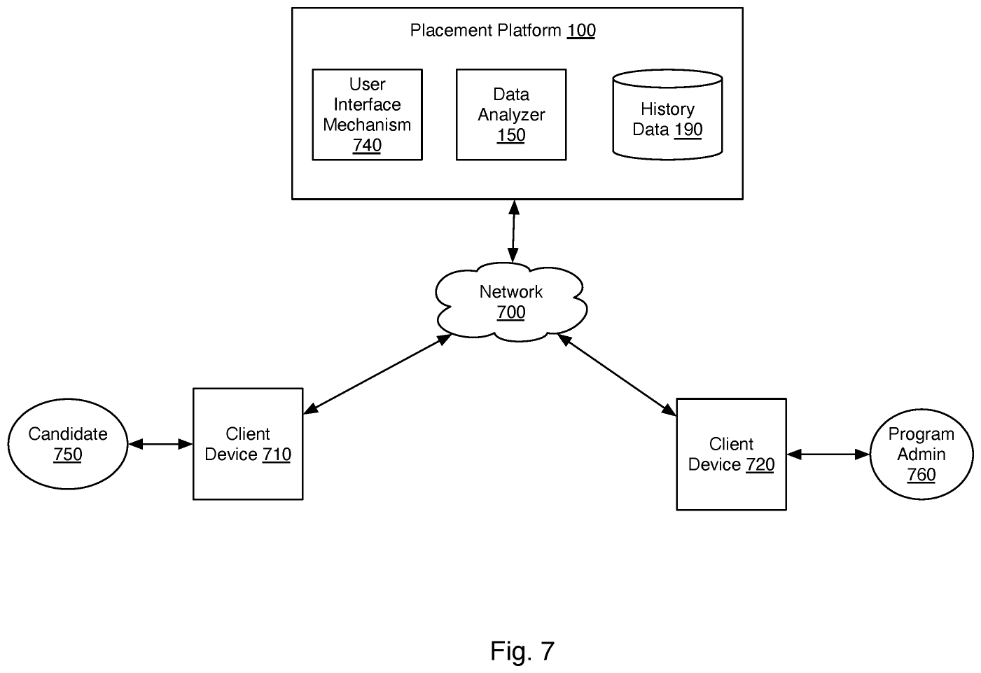

FIG. 7 illustrates an example cloud-based implementation of the placement platform 100 in which a candidate 750 and a program admin 760 access the placement platform 100 via a network 700 using, e.g., internet protocols, via respective client devices 710 and 720. The client devices 710 and 720 can be mobile devices, desktop computers, etc. The placement platform 100 includes a user interface mechanism 740 that generates user interfaces, e.g., home pages, dashboards, etc., accessed by the candidate 750 and the program admin 760, including desirability indicators as disclosed above.

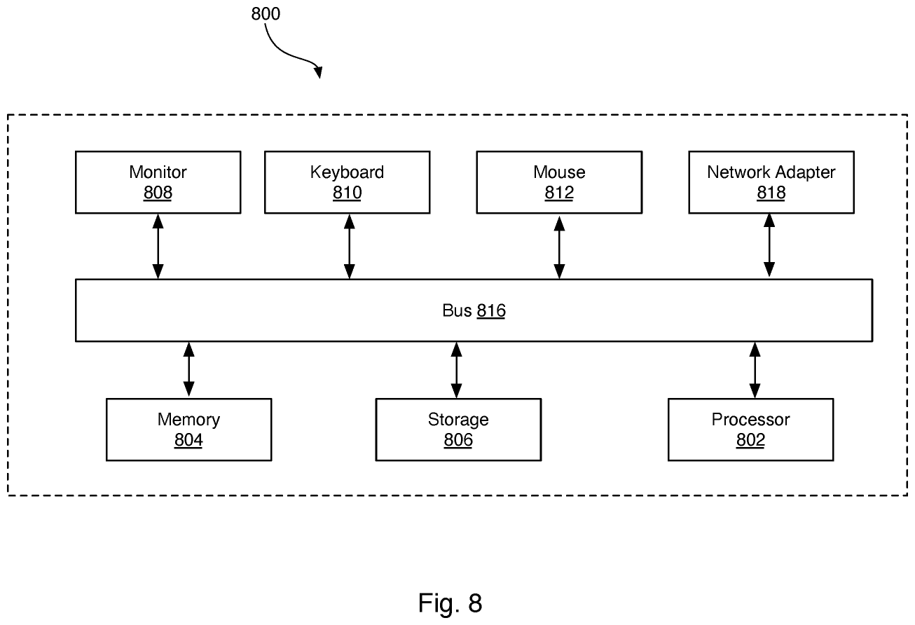

FIG. 8 illustrates a computing system 800 upon which portions of the placement platform 100 can be implemented. The computing system 800 includes one or more computer processor(s) 802, associated memory 804 (e.g., random access memory (RAM), cache memory, flash memory, etc.), one or more storage device(s) 806 (e.g., a hard disk, an optical drive such as a compact disk (CD) drive or digital versatile disk (DVD) drive, a flash memory stick, etc.), a bus 816, and numerous other elements and functionalities.

The computer processor(s) 802 may be an integrated circuit for processing instructions. For example, the computer processor(s) may be one or more cores or micro-cores of a processor. The computing system 800 may also include one or more input device(s), e.g., a touchscreen, keyboard 810, mouse 812, microphone, touchpad, electronic pen, or any other type of input device. Further, the computing system 800 may include one or more monitor device(s) 808, such as a screen (e.g., a liquid crystal display (LCD), a plasma display, touchscreen, cathode ray tube (CRT) monitor, projector, or other display device), external storage, input for an electric instrument, or any other output device. The computing system 800 may be connected to, e.g., a local area network (LAN), a wide area network (WAN) such as the Internet, mobile network, or any other type of network) via a network adapter 818.

While the foregoing disclosure sets forth various embodiments using specific diagrams, flowcharts, and examples, each diagram component, flowchart step, operation, and/or component described and/or illustrated herein may be implemented, individually and/or collectively, using a range of processes and components.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While the invention has been described with respect to a limited number of embodiments, those skilled in the art, having benefit of this disclosure, will appreciate that other embodiments may be devised which do not depart from the scope of the invention as disclosed herein.

What is claimed is:

1. A placement platform, comprising:
a user interface that includes an indicator of a relative desirability of at least one of a plurality of programs registered on the placement platform among a set of candidates who use the placement platform to place among the programs; and
a data analyzer that determines the relative desirability in response to a store of history data pertaining to how the candidates used the placement platform to place among the programs during at least one placement season for the programs.

2. The placement platform of claim 1, wherein the data analyzer determines the relative desirability by determining a rate of completion of one or more events associated with each program.

3. The placement platform of claim 1, wherein the data analyzer determines the relative desirability by determining a set of competitors among the programs in response to the history data.

4. The placement platform of claim 3, wherein the data analyzer determines the competitors by determining an overlap among the candidates who sought placement in the programs.

5. The placement platform of claim 4, wherein the overlap is based on a respective candidate profile of each of the candidates who sought placement.

6. The placement platform of claim 4, wherein the overlap is based on a respective set of questionnaire answers of each of the candidates.

7. The placement platform of claim 3, wherein the data analyzer determines the competitor by determining an overlap among a set of dates pertaining to one or more events held by the respective programs.

8. A method for indicating desirability of program placement, comprising:
generating a user interface that includes an indicator of a relative desirability of at least one of a plurality of programs registered on a placement platform among a set of candidates who use the placement platform to place among the programs; and
determining the relative desirability in response to a store of history data pertaining to how the candidates used the placement platform to place among the programs during at least one placement season for the programs.

9. The method of claim 8, wherein determining the relative desirability comprises determining a rate of completion of one or more events associated with each program.

10. The method of claim 8, wherein determining the relative desirability comprises determining a set of competitors among the programs in response to the history data.

11. The method of claim 10, wherein determining the competitors comprises determining an overlap among the candidates who sought placement in the programs.

12. The method of claim 11, wherein the overlap is based on a respective candidate profile of each of the candidates who sought placement.

13. The method of claim 11, wherein the overlap is based on a respective set of questionnaire answers of each of the candidates.

14. The method of claim 10, wherein determining the competitors comprises determining an overlap among a set of dates pertaining to one or more events held by the respective programs.
